(19) United States
(12) Patent Application Publication
(10) Pub. No.: US 2007/0188873 A1
(43) Pub. Date: Aug. 16, 2007

(54) Electrically controlled display material

(76) Inventor: Mark Wardas, New York, NY (US)

Correspondence Address: Mark Wardas, 192 East 75th St. #5c, New York, NY, 10021, US

(21) Appl. No.: 11/704,110

(22) Filed: Feb. 8, 2007

Related U.S. Application Data
(60) Provisional application No. 60/774,049, filed on Feb. 16, 2006.

(51) Int. Cl. G02B 27/00

(52) U.S. Cl. 359/609

(57) ABSTRACT

A display window for selectively passing illumination emanating from one or more artificial light source is described to comprise a display material with a transparency that may be controlled to pass a substantially constant amount of the illumination from the one or more artificial light source and through the display material regardless of the amount of the illumination.

### RELATED APPLICATIONS

The present invention is related to and claims priority from commonly owned Provisional Application Ser. No. 60/774,049, filed Feb. 16, 2006, which is incorporated herein by reference.

### FIELD

The invention is generally related to preservation of articles illuminated under light and more specifically related to preservation of articles illuminated under artificial light.

### BACKGROUND

Environmental conditions are known to cause many types of articles to rapidly degrade in quality and/or appearance. Degradation can occur due to interactions caused by many factors, including temperature, air, and light.

In the prior art, a clear plastic or glass display case is sometimes used to protect articles from the effects of air and temperature. With some display cases, the interior is sealed from the exterior air to limit effects on, and interactions with, the articles. With some display cases, the interior air within the case is removed and replaced by an inert gas, such as nitrogen, argon, or the like. Display cases of the type described above are found in many museums and exhibition halls, and are typically very large, very heavy, and very complicated to maintain.

Another environmental condition includes exposure to light, both natural and artificial, the effects of which can interact with articles and/or any items in the vicinity of the articles, for example, items made of plastic and/or paper. Light comprises wavelengths of ultraviolet (UV), visible, and infrared light. In the prior art, during periods of non-display and storage, articles and the other items in their vicinity are typically protected from the effects of light via use of display case filters and shields. To further shield against the effects of light, UV filters and/or opaque shields may be placed or adhered to exterior facing windows and interior lights that are within the display or movement area of the articles. A very informative web site that discusses the effects of visible light and other environmental factors on paper based articles can be referred to for further information at www.stampsrart.com.

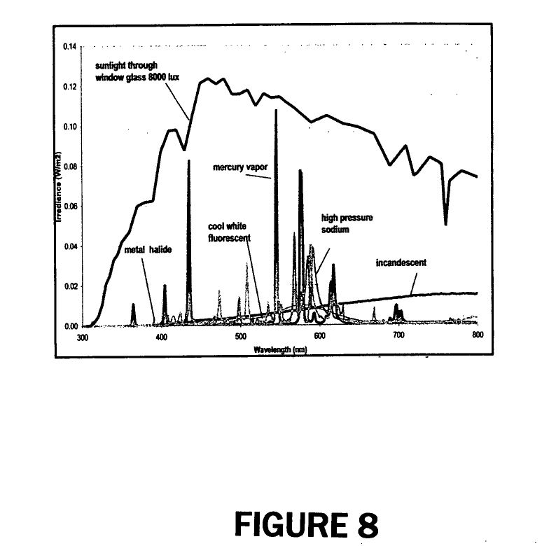

Referring now to FIG. 8, there is seen a chart showing the wavelengths and the amount of different types of interior and exterior light that potentially can be present within an interior of a windowed structure. Because interior artificial sources of visible light can be relied upon to provide sufficient illumination, the intense and destructive exterior sources of visible light can be totally blocked via shields or curtains placed over exterior facing windows. Although filters and/or shields can be used to minimize, if not eliminate, the UV and infrared components of both the artificial and natural light that is represented by FIG. 8, unfortunately, the goal of elimination cannot be applied in the same manner to visible light, which is needed by humans to visually see (i.e. to view articles with).

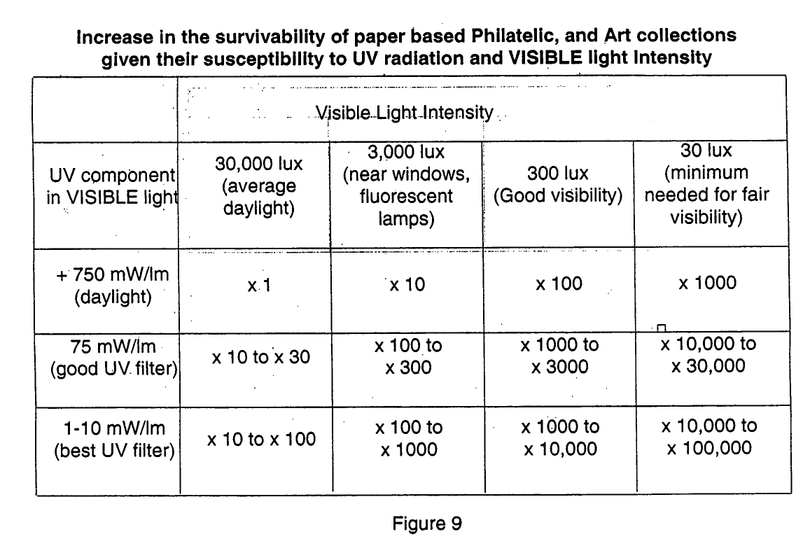

Referring now to FIG. 9, there is seen a chart that illustrates relative effects of visible light. Although, as discussed above, the harmful effects of natural visible light from external sources can be eliminated, the harmful effects of indoor artificial visible light (which is usually left turned on for long periods of the time, even when there may be no viewers present) can nevertheless still cause significant damage and, thus, should always be considered when illuminating aesthetic, historical, rare, and/or valuable articles. Representative values of visible light measured in by a light meter in lux under various types of indoor and outdoor settings include: about 100,000 lux present under direct outdoor natural sunlight, about 10,000 lux present under shaded outdoor natural sunlight, about 5000 lux present under indoor natural sunlight illuminated, about 1000 lux present under artificial halogen lights, a range of about 125 lux present under a 100 watt tungsten bulb measured at 3 feet, 1 lux present under a candle measured at one foot. The amount of visible light that can be present under indoor visible light is illustrated in FIG. 9 by a set of ranges that span 3000 lux to 30 lux. FIG. 9 illustrates that depending on a level of UV light also present, the possible damage that can be inflicted on an article exposed to visible light can span a 10,000 fold range. Exposure to visible light is cumulative such that cumulative exposures to 100-500 lux of artificial visible light (a range of amounts that are present in typical homes and offices) can cause sensitive material (for example art prints, stamps, etc) to begin fading in as few as one or two years. In other words, if preservation is a goal, the harmful effects of visible light, whether artificial or natural cannot be ignored. In the prior art, for example in museum like settings, the amount of visible light from artificial sources is typically reduced by a simple technique of “lowering the lights,” which may include reduced wattage overhead lighting, or the flipping or turning of a switch to lower their intensity. Such techniques are highly dependant on someone, or something, being able to track and control the level of the light and, for this reason, in many instances, where artificial visible light has been identified as being of concern, the light is permanently kept in a dimmed condition. In the prior art, reduction of visible light is consequently achieved at a cost, for example, as occurs in the National Archives in Washington D.C., where treasures such as the Declaration of Independence are made much less enjoyable to view and study because of the uncomfortably low levels of illumination by artificial light (about 50 lux) that is used. Although museums such as The National Archives have the resources to be able to implement all that is needed maintain their levels of light, because of cost and practicality, private collectors typically and simply store their articles in containers and albums, and make them available for exhibition and viewing only intermittently. Unfortunately, when they do view or display their articles, private collectors do so by exposing them to the full effects of any indoor light and other environmental factors that may be present.

From time to time, it may be desired to more closely view a particular article, if not for personal pleasure, then for display, inspection, and the like. When prior art display cases are used for display or storage, such close inspection can normally be achieved only after a complicated and/or time consuming process by which the display case is unsealed and/or opened. To minimize degradation of an article after removal from a prior art display case, additional filtering of light and climate control typically needs to be provided. With museums, the resources for implementation of additional climate control and light filtering is normally readily available, however, with private collectors, the apparatus and methods needed are typically too expensive and/or too difficult to implement. Thus, with private collectors, containers and albums to this day remain the storage method of choice. Because containers and albums in themselves provide no protection against light when open, and very little if any protection against other environmental effects, articles in private collections are typically subject to much more degradation than those in museums.

Two technologies that can be used to reduce transmission of light include photochromic and thermochromic technology. A property of photochromic material is that its transparency varies as a function of the amount of UV light it is exposed to. An example of photochromic technology known to those skilled in the art is that which is used to provide sunglass functionality, wherewith in the presence of UV light, eyeglass lenses can be made to darken, and in the absence UV light, to lighten. Thermochromic technology is also known to provide light blocking functionality, but in response to changes in temperature and/or infrared wavelengths.

Although changes in transparency and opaqueness of photochromic material can be used to block visible light, a limitation arises in that the particular transparency of photochromic material can be made to change as a function of the UV light present. In situations where UV light has been prefiltered, for example by a UV filter placed over exterior facing windows and/or interior light fixtures, the photochromic functionality does not become activated. In such a case, where no, or very little, UV light is present, if it were desired to rely upon a photochromic material to shield an article from visible light, the photochromic material would fail to do so, and the article so shielded would remain exposed to its degrading effects.

Another type of light reducing technology is known as electrochromic technology. Electrochromic technology has recently been commercially developed for use with automotive rearview mirrors to dim the reflected brightness of headlights in the rearview mirror. Another recent application of electrochromic technology is in window glazing units, wherewith the transparency of a building's exterior facing windows can be electrically controlled to reflect or retain infrared light (i.e. heat) to improve buildings energy efficiency. A type of electrochromic window is sold commercially by Sage Electrochromics, One Sage Way, Faribault, Minn.

Thus, it would be desirable to improve upon one or more of the limitations of the prior art to minimize damage from light to articles during periods of display, viewing, and storage.

### SUMMARY

The present invention facilitates preservation of articles while at the same time minimizing and eliminating the limitations that the prior art imposes on the ability to view, display, exhibit, and enjoy the articles. In contrast to the prior art, the present invention enables preservation of articles via selective filtering of interior, exterior, and/or other environmental effects. In one embodiment, selective filtering is achieved via a self contained apparatus that minimizes and in some cases eliminates the need for heavy and bulky housings and/or additional environmental controls and connections. In one embodiment, selective filtering is achieved via an apparatus that can be readily moved from one location to another. In one embodiment, an apparatus for selective filtering comprises a self contained unit. In one embodiment, an apparatus for selective filtering can be made to be attached to, or be part of, housing. In one embodiment, an apparatus for selective filtering may be made to be a removable part of housing.

In one embodiment, at least one display window for selectively shielding articles from illumination emanating from one or more artificial light source comprises a display material capable of having a plurality of states of transparency that are electrically controllable to selectively pass the illumination through the display material and so as to selectively limit illumination of articles in the path of the illumination, wherein after the illumination passes through the display material it is limited by the display material to a predetermined amount of illumination. In embodiments, the artificial light source may comprise incandescent, halogen, fluorescent, tungsten, arc, tungsten halogen, high-intensity discharge, LED, Low Pressure Sodium, Metal Halide, and/or Mercury Vapor light sources. In one embodiment, the display material comprises at least one layer of electrochromic material. In one embodiment, the display material is coupled to at least one circuit element, wherein upon detection of an event, the at least one circuit element generates a signal, and wherein the signal is functionally coupled to the display material to change a state of its transparency from a first state to a second state. In embodiments, the detection of an event may comprise an amount of visible light illumination, an amount of infrared light illumination, an amount of UV light illumination, an environmental condition, presence of an article, presence of person, and/or a time of day. In one embodiment, the detection of an event comprises a measurement of an amount of the illumination before the illumination passes through the display material. In one embodiment, detection of an event comprises a measurement of an amount of the illumination after the illumination passes through the display material. In one embodiment, wherein when the measurement comprises more than a particular value, the signal is operatively coupled to the display material to change a state of the display material to be more darkened, and wherein when the measurement comprises less than the particular value, the signal is operatively coupled to the display material to change a state of the display material to less darkened. In one embodiment, the predetermined amount of illumination is in a range between about 50 lux and about 100 lux. In one embodiment, the predetermined amount of illumination is less than about 500 lux.

In one embodiment, an apparatus to control illumination of one or more article by visible light comprises a display case, the display case comprising a plurality of side portions, wherein the side portions define a space within which the one or more articles can be disposed, wherein at least one of the plurality of side portions comprises a material that can be controlled to have a plurality of transparencies; and a source of voltage, wherein a selective application of the voltage to the material controllably changes a transparency of the material, wherein during periods of viewing of any articles that may be disposed within the space a selective application of the voltage is used to change a transparency of the material to allow the space to be illuminated with a level of the visible light that is comfortable for viewing and at the same time to limit damage that could be caused to the articles by the visible light, and wherein during periods of non-viewing a selective application of the voltage is used to change a transparency of the material to be in a substantially darkened state to further limit visible light damage to any of the articles that may be disposed within the space. In one embodiment, a material comprises an electrochromic material. In embodiments, articles that may be disposed within the space comprise: paintings, art prints, art items, philatelic items, stamps, photos, documents, letters, books, and artifacts. In one embodiment, the display case comprises a moveable frame. In one embodiment, the display case comprises an encapsulation. In one embodiment, the display case comprises a picture or painting frame. In one embodiment, a difference in the amount of illumination present within the space when a transparency of the material is changed between a substantially clear state and a substantially darkened state does not exceed about 3000 lux. In one embodiment, a difference in the amount of illumination present within the space when a transparency of the material is changed between a substantially clear state and a substantially darkened state does not exceed about 1000 lux of visible light. In one embodiment, a difference in the amount of illumination present within the space when a transparency of the material is changed between a substantially clear state and a substantially darkened state does not exceed about 5000 lux of visible light.

In one embodiment, a method of displaying and protecting an article placed under the illumination of visible light comprises positioning an article on a support; positioning an electrochromic material between the article and a source of the visible light; and electrically controlling a transparency of the electrochromic material to controllably vary illumination of the article by the visible light. In one embodiment, the illumination of the article is controllably limited to a value. In one embodiment, the value is in a range of about 50 to 500 lux. In one embodiment, the visible light comprises artificial visible light. In embodiments, the article comprises one or more of: paintings, art prints, art items, philatelic items, stamps, photos, album pages, documents, letters, books, artifacts, and storage containers.

In one embodiment, an apparatus comprises a visible light transmission means for selectively illuminating an article with visible light, whereby damage to the article from degrading effects caused by the visible light is minimized during periods of illumination of the article.

Other features, aspects, benefits, advantages, and embodiments are also within the scope of the present invention, and will be better understood with reference to the Description, Drawings, and claims that follow.

### FIGURES

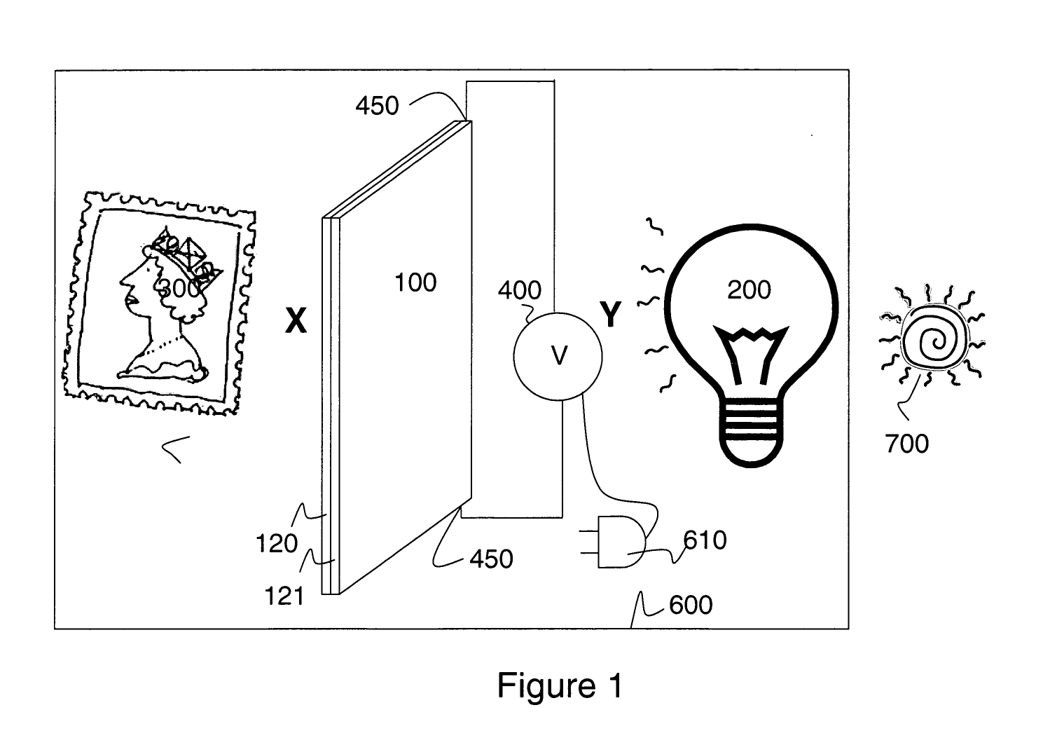

In FIG. 1 there is seen a representation of a material disposed between an article and an artificial and/or indoor source of light.

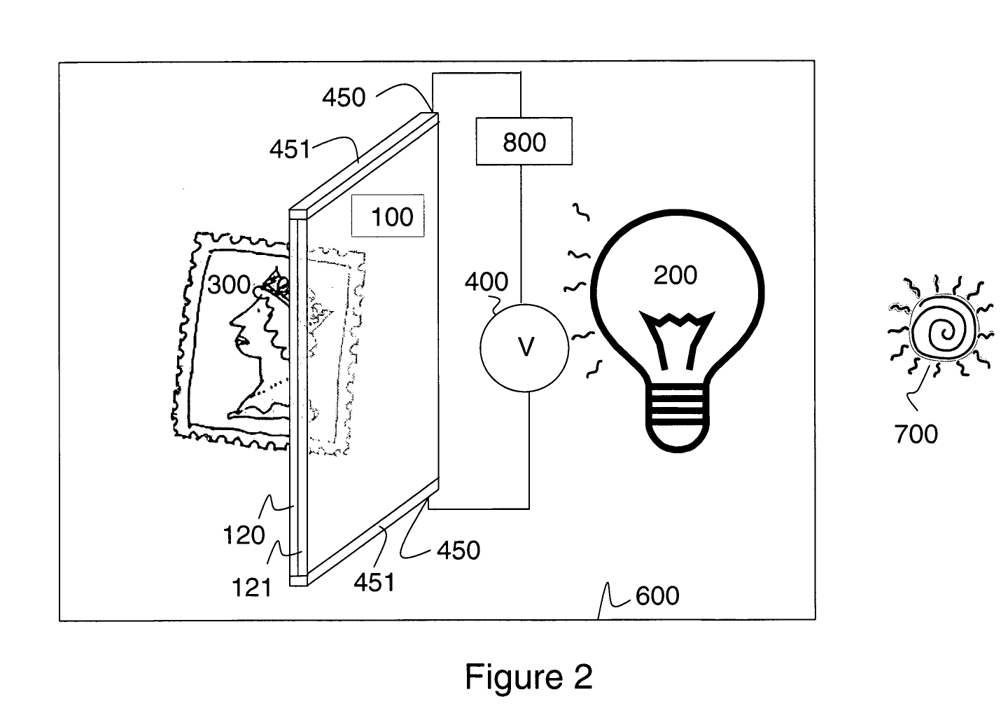

In FIG. 2 there is seen a representation of a material in a transparent state that can be selectively controlled to be between opaque/darkened and bleached/clear.

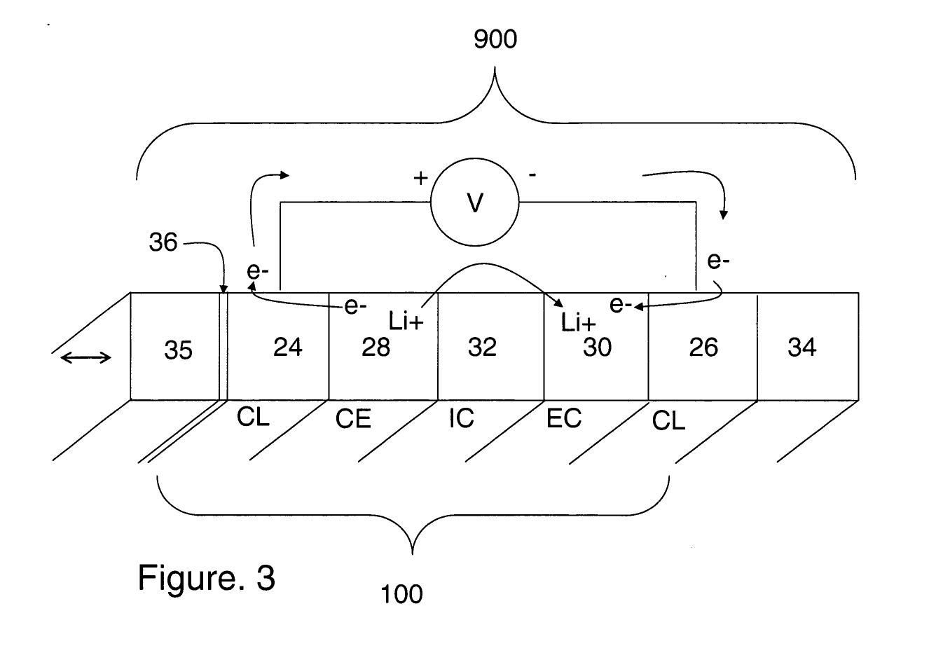

In FIG. 3 there is seen a three dimensional not to scale cross section representation of layers of a material, through light may be selectively blocked or passed.

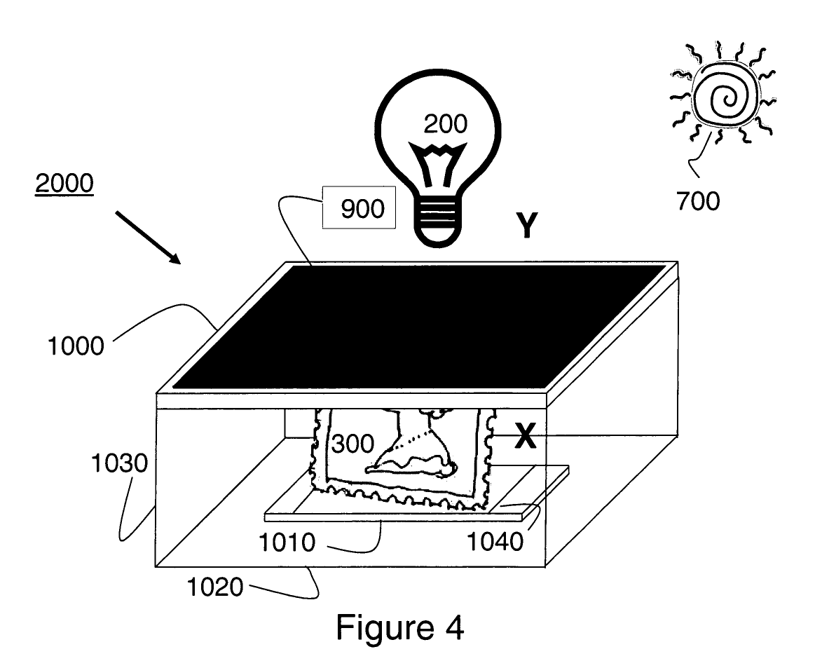

In FIG. 4 there is seen a representation of a display case.

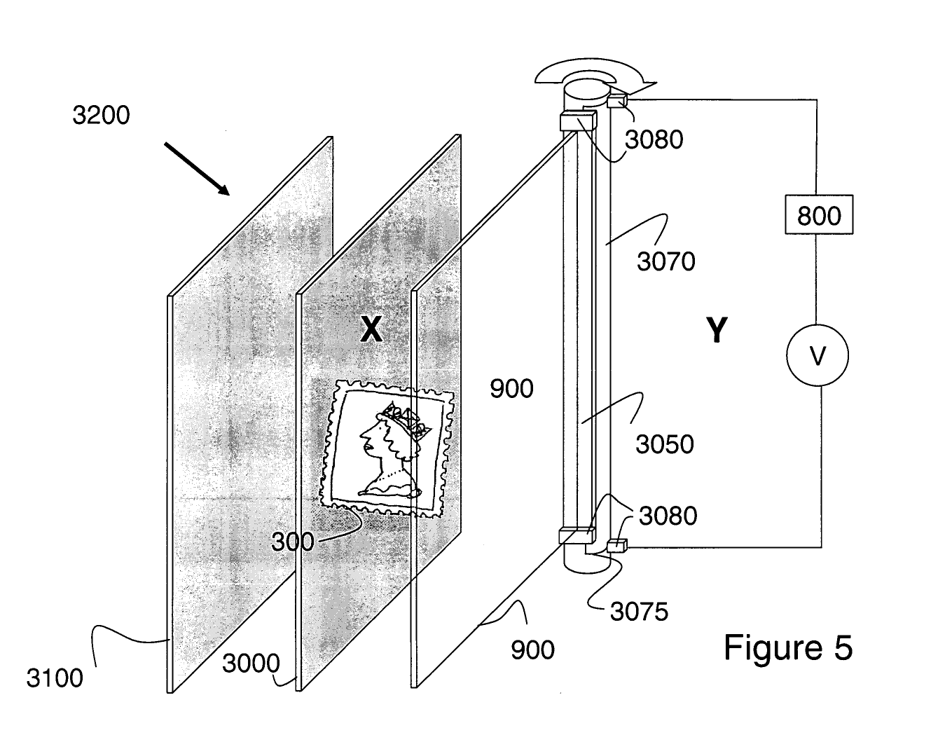

In FIG. 5 there is seen an exploded view of an exemplary apparatus.

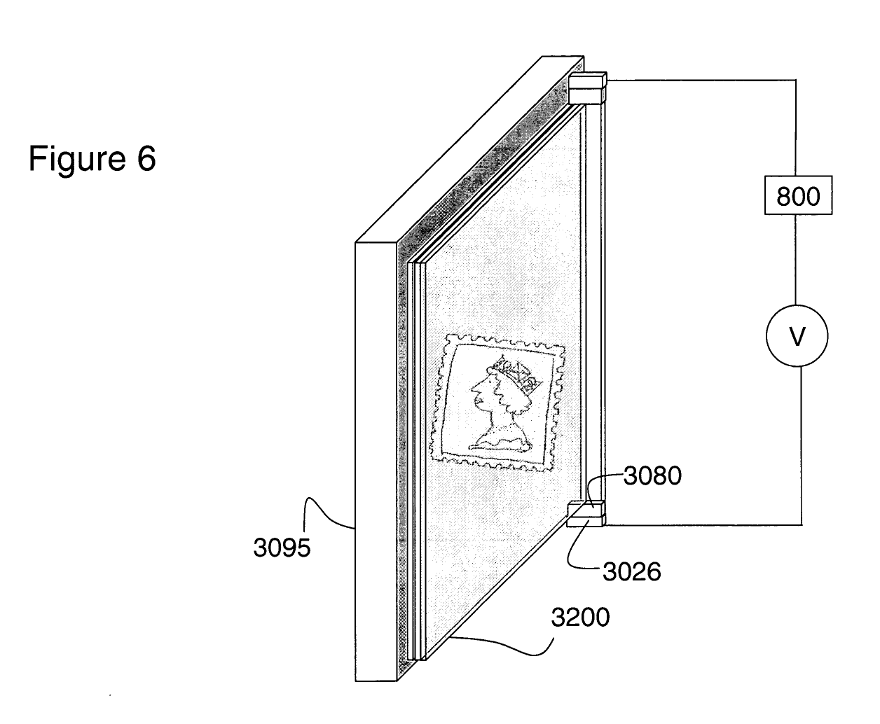

In FIG. 6 there is seen an exploded view of an exemplary apparatus.

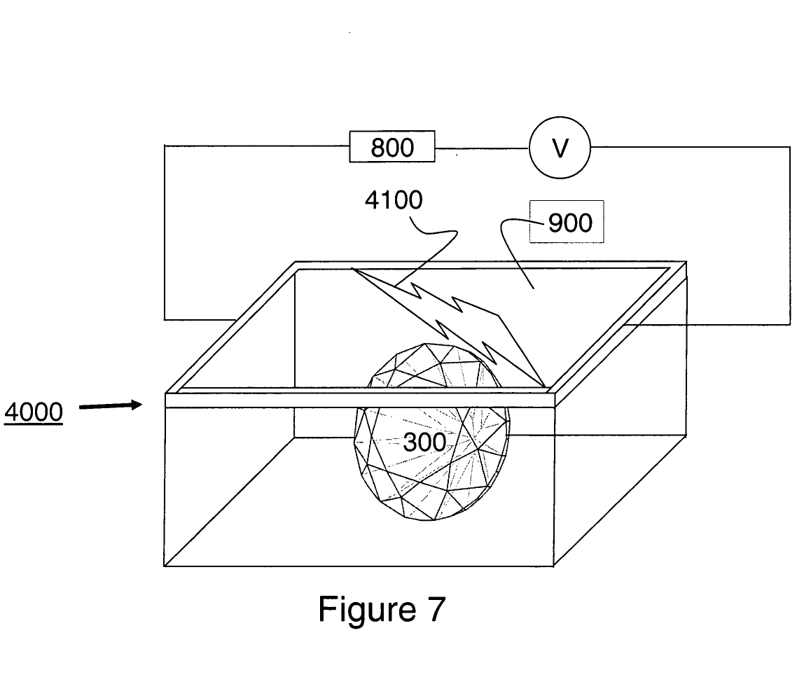

In FIG. 7 there is seen a representation of a failure mode of a display material.

In FIG. 8 there is seen a chart showing the wavelengths and the amount of different types of interior and exterior light that potentially can be present within an interior of a windowed structure.

In FIG. 9 there is seen a chart that illustrates relative effects of visible light.

### DESCRIPTION

Reference will now be made in detail to several embodiments of the invention that are illustrated in the accompanying Drawings. Wherever practicable, same or similar reference numerals are used in the Drawings and the Description to refer to the same or like parts or steps; however, to simplify the disclosure, the same or similar reference numerals may in some instances refer to parts or steps that comprise variants of one another. The Drawings are in simplified form and not to precise scale. For purposes of convenience and clarity directional terms, such as top, bottom, left, right, up, down, over, above, below, beneath, rear, and front may be used with respect to the accompanying drawings. These and similar directional terms should not be construed to limit the scope of the invention in any manner. The terms “couple,” “connect” and similar terms with their inflectional morphemes are used interchangeably, unless the difference is noted or otherwise made clear from the context. These terms do not necessarily signify direct connections, but may include connections through intermediate components and devices. Details in the Description and Drawings are provided to enable and understand inventive principles and embodiments described herein and, as well, to the extent that would be needed by one skilled in the art to implement the principles and embodiments in particular applications that are covered by the scope of the claims. The term “article” may be depicted, described, or refer to specific type of article herein, but it should be understood that the scope of the articles that the embodiments of the present invention may be implemented for use with used with is almost unlimited, and for this reason, the present invention should be limited only by the scope of the claims that follow. The term “embodiment(s)” may refer to a particular apparatus or process, and not necessarily to the same apparatus or process. Thus, the number of potential embodiments is not necessarily limited to one or any other quantity.

Referring to FIG. 1, and other Figures as needed, there is seen a representation of a material disposed between an article and an artificial and/or indoor source of light. In one embodiment, the material 100 comprises one or more electrically responsive layer 120/121. In one embodiment, material 100 can be electrically controlled to selectively change its ability to pass or block visible, ultraviolet (UV), and infrared wavelengths of light (hereafter referred to as transparency, which may further be referred to further herein as states of transparency that include opaque/darkened, bleached/clear, and states therebetween) In one embodiment, a particular application of a voltage V across one or more electrically responsive layer 120/121 causes material 100 to change to a particular state (shown in FIG. 1 to be in a generally clear state). In a preferred embodiment, the material 100 is disposed between an article 300 and an artificial indoor source of light 200, for example, incandescent, halogen, fluorescent, tungsten, arc, tungsten halogen, high-intensity discharge (HID), light emitting diode (LED), Low Pressure Sodium (SOX), Metal Halides (MH), and Mercury Vapor Lamps (MVR) and/or other sources of light as may be used to illuminate the interior 600 of building like structures such as homes, offices, museums, exhibition halls, arenas, and the like. In one embodiment, wherein a source of visible light 200 emits an illumination of about 500 lux, as may be present in a typical home or office and as could be measured by a light meter at a position (as indicated generally by Y) to one side of the material 100, and with the material 100 in a generally clear state, the illumination of the artificial source of light 200 is measured to be respectively between about 450 lux at a position (as indicated generally by X) to another side of the material 100, with this reduction in the illumination resulting because in some embodiments even in a substantially clear state, a material 100 may not be completely clear, for example, because of one or more of inherent characteristics of the material 100 used. In other embodiments, the material 100 may be disposed between an article 300 and a natural source of light 700, for example as may be present exterior to a building structure 600; or the material 100 may be disposed at a position between an article 300 and both a natural source of light 700 and an artificial source of light 200. In one embodiment, the material 100 is operatively attached or coupled to one or more electrical connection 450, via which a voltage V from a voltage source 400 is applied. In one embodiment, an electrical connection 450 comprises one or more conductive lead, conductive trace, conductive electrometric, edge connector, a solder connection, and/or other connections as could be implemented by those skilled in the electrical connection arts. In one embodiment, the voltage V comprises particular amplitude and/or current and/or polarity and/or frequency, as could implemented by those skilled in the voltage source arts, and as would be needed to selectively change a state of the transparency of material 100.

Referring now to FIG. 2, and other Figures as needed, there is seen a representation of a material in a transparent state that can be selectively controlled to be between opaque/darkened and bleached/clear. In embodiments, application of a particular voltage V to material 100 can be used to effectuate a particular transparency of material 100 to be in a darkened state, a clear state, or a state between a darkened and clear state. Accordingly, in an exemplary embodiment, with a source of visible light 200 that emits a range of illuminations of about 100 to 500 lux as could be measured by a light meter at a position (as indicated generally by Y) to one side of the material 100, and with a transparency of the material 100 in a particular state between a darkened state and a clear state, the illumination of the artificial source of light 200 may be measured to be no more than between about 50 to 100 lux at a position (as indicated generally by X) to another side of the material 100.

Referring now to FIG. 3, and other Figures as needed, there is seen a three dimensional not to scale cross section representation of layers of a material, through which light may be selectively blocked or passed. In a preferred embodiment, a material 100 comprises an electrochromic material. FIG. 3 shows a material 100 that comprises five layers. In an exemplary embodiment, the five layers include an electrochromic layer (“EC”) 30 which produces a change in absorption or reflection upon oxidation or reduction; an ion conductor layer (“IC”) 32 which serves as an electrolyte, allowing the passage of ions while blocking electronic current; a counter electrode (“CE”) 28 which serves as a storage layer for ions when the device is in the substantially state; and two conductive layers (“CL”) 24 and 26 which serve to allow application of an electrical potential or voltage V to the material 100. In one embodiment, each of the aforementioned layers may be applied sequentially on a substrate 34. In one embodiment, a voltage V is connected to the material via layers 24 and 26, the selective application of which preferably causes the material 100 to change a state of its transparency. In one embodiment, the polarity of the voltage V governs the nature of the electrical potential created and, thus, the direction of ion and electron flow between the layers. In the embodiment depicted in FIG. 3, an electrical potential that is created causes LI ions to flow from the counter electrode layer 28 through the ion conductor layer 32 to the electrochromic layer 30, thereby causing a decrease in the state of a transparency of the material 100. Application of a reverse voltage V may initiate a reverse reaction that increases a state of a transparency of the material 100.

The materials employed for the conductive layers 24 and 26 are well known to those skilled in the art. Exemplary conductive layer materials include coatings of indium oxide, indium tin oxide, doped indium oxide, tin oxide, doped tin oxide, zinc oxide, doped zinc oxide, ruthenium oxide, doped ruthenium oxide and the like, as well as thin metallic coatings that are substantially transparent, such as transition metals including gold, silver, aluminum, nickel alloy, and the like. It is also possible to employ multiple layer coatings, such as those available from Pilkington under the trade name of TEC-Glass®., or those available from PPG Industries under the trade names SUNGATE®. 300 and SUNGATE®. 500. The conductive layers 24 and 26 may also comprise composite conductors prepared by placing highly conductive ceramic and metal wires or conductive layer patterns on one of the faces of a substrate 34 and then overcoating with transparent conductive materials such as indium tin oxide or doped tin oxides. The conductive layers 24 and 26 may as needed be further treated with appropriate anti-reflective or protective oxide or nitride layers. U.S. Pat. No. 6,856,444 discloses other embodiments of electrochromic device compositions and manufacture, which is incorporated herein by reference in its entirety. It should be understood, however, that although electrochromic technology is described as being preferred, other technologies that that can selectively be controlled to change states of transparency are also within the scope of the present invention, and for this reason the embodiments described herein should be limited only by the scope of the claims.

Referring back to FIG. 1, and other Figures as needed, in one embodiment, a transparency of a material 100 is initially in a substantially clear state, wherein application of a first voltage V to the material 100 causes ions and electrons to migrate from a first layer 120 of the material to a second layer 121 of the material; in doing so, a transparency of the material is caused to change from a substantially clear state to a substantially darkened state. In one embodiment, a substantially darkened state of a material 100 can be maintained after a first voltage V is removed. In one embodiment, after a first voltage V is removed, ions and electrons migrate from a second layer 121 to a first layer 120, which causes a transparency of the material 100 to change to a substantially clear state. In one embodiment, application of a second voltage V having a polarity opposite to the first voltage V causes the ions to migrate from the second layer 121 to the first layer 120 more rapidly and to thereby cause the material 100 to change its state to clear more rapidly.

In one embodiment, a transparency of a material 100 is initially in a substantially darkened state, wherein application of a third voltage V to the material causes ions and electrons to migrate from a second layer 121 of the material to a first layer 120 of the material 100; in doing so, a transparency of the material is caused to change from a substantially darkened state to a substantially clear state.

In one embodiment, a substantially clear state of a material 100 can be maintained after a third voltage V is removed. In one embodiment, after a third voltage V is removed, ions and electrons migrate from the first layer 120 to the second layer 121, which causes a transparency of the material 100 to change to a substantially darkened state. In one embodiment, application of a fourth voltage V having a polarity opposite to the third voltage V causes the ions to migrate from the first layer to the second layer more rapidly and to thereby cause the material 100 to change its state to darkened more rapidly.

It is identified that a material 100 as described herein may in some instances advantageously utilize one or more structures 451, which in embodiments can be used to enable protection, support and/or electrical connections, movement, handling, mounting, and other functionality that may be desired or needed. In exemplary embodiments, one or more structures 451 may comprise one or more of a conductive or non conductive support edge, protective edge, support frame, or the like.

Referring back to FIG. 3, and other Figures as needed, in one embodiment, it is envisioned that a material 100 itself may comprise a substrate, for example as may be effectuated via its formation as a support matrix. In a preferred embodiment, one or more layers of a material 100 may be coupled or attached to a substrate 34. In one embodiment, substrate 34 may be used to provide a surface onto which one or more layer of material 100 can be deposited. In one embodiment, a material 100 may also be attached or coupled to one or more other substrate 35. In one embodiment, one or more other substrate 35 may be separated from the material 100 by a space or air gap 36. In one embodiment, a space or air gap 36 may comprise a hermetically sealed space within which inert gas and/or desiccants may be used disposed, as could be implemented by those skilled in inert gas and desiccant arts. In one embodiment, one or more of substrates 34 and/or 35 can be used to protect material 100 from damage, contact, environmental degradation, or the like. In a preferred embodiment, substrate 34 and/or substrate 35 are substantially clear. In embodiments, substrate 34, and if used substrate 35, may comprise one or more of a glass, a plastic, a glass plastic combination, a film, a coating, or the like. In embodiments, a substrate 34 may comprise a flexible characteristic, a semi-rigid characteristic, a rigid characteristic, or the like. In a preferred embodiment, substrate 34 is substantially flat, but it is identified that many other geometries, for example, non-flat, curved, concave, convex, spherical, etc. are also within the scope of the present invention, which should be thus limited only by the claims that follow.

In an exemplary embodiment, a combination of material 100 and substrates 34 and/or 35 (hereafter collectively referred to as display material 900) collectively exhibit the following transmittance in a substantially darkened state: visible 3.5%, infrared 1.5%, UV 0.8%, KDF 2.2%; and the following reflectance: VIS in 10%, VIS out 6%, infrared 10%. In an exemplary embodiment, the display material 900 comprises the following transmittance in a substantially clear state: visible 62%, infrared 40%, UV 5.6%, KDF 18%; and the following reflectance: VIS in 15%, VIS out 21%, infrared 20%. In other embodiments, the display material 900 may comprise transmittance and reflectance values as may be effectuated via selective application of a particular voltage V. To effectuate the above exemplary embodiments, substrate 34 and/or 35 may include thereon additional coatings or layers of UV and infrared wavelength filtering material, which may add to any filtering of UV and infrared wavelengths of light that may be inherent to the display material 900 itself, but in other embodiments it is understood that use of additional coatings or layers may not be needed or desired. Accordingly, it is understood, that the present invention should not be limited to the exemplary values of transmittance and reflectance, as other values of transmittance and reflectance are also within the scope of the present invention, which should be limited only by the claims that follow.

In one embodiment, to minimize exposure of an article 300 to light, a transparency of a display material 900 is maintained in a substantially darkened state during periods of non-display or storage. In one embodiment, during periods of display, a viewer or other person may be given control over application of voltage V to display material 900, in which case the viewer or other person could be given control over the transparency of the display material 900 and, as well, control over the amount of visible light with which he/she could illuminate an article 300 with. It is identified that independent of a particular transparency of display material 900, a display material 900 may itself provide substantial filtering of UV and/or infrared light all the time, both during periods of viewing, non-viewing, and storage, such that an article 300 placed under a display material may be substantially protected from all but visible light all the time. Thus, whether or not a user was given control over voltage V, the prior art use of external UV filters, external shields over room lights and windows, and/or reduction of room illumination can be minimized or eliminated, and enjoyment and control over viewing of an article 300 can be accordingly enhanced. Nevertheless, it is identified that during the periods of time that a user might be given control over voltage V, an article 300 could be undesirably exposed to more than an acceptable amount of visible light. Accordingly, in one embodiment, user control over the transparency of a material 100 (i.e. control over the voltage V) can be intentionally limited to allow only some, but not all, visible light to pass through the material to provide illumination of an article 300. In one embodiment, whether a person is provided control over voltage V, upon the occurrence and/or detection of an event, voltage V may be controlled by one or more circuit or circuit element 800, as could be implemented by those skilled in the electronic arts.

In one embodiment, upon the occurrence and/or detection of an event, one or more circuit or circuit element 800 generates a signal and/or a voltage V, whereby the voltage V is applied to material 100 so as to selectively effectuate a change in the material's transparency. In embodiments, an event may occur and/or be detected at positions generally indicated as X and/or Y, as could occur on either side of a material 100. In embodiments, an event may be detected by a sensor that is operatively coupled to the one or more circuit element 800. In embodiments, the event comprises a particular level of illumination by visible light, illumination by infrared light, illumination by UV light, an environmental condition, the presence of an article or person, a time of day, or other events that may naturally or unnaturally occur at, near, or in the vicinity of an article 300. In one embodiment, a particular level of visible light illumination is that which is present at a position (generally indicated by Y) between material 100 and an indoor source of light 200. In one embodiment, a particular level of visible light illumination is that which is present at a position (generally indicated by X) between material 100 and an article 300.

In a preferred embodiment, an event comprises detection of a level of visible light illumination that is desired to be present at a position (generally indicated by X) between a material 100 and an article 300. In a preferred embodiment, a level of visible light illumination that is desired is a particular value and/or within in a range of about 50-100 lux, which within a range of visible light that is accepted by most museums as being the maximum amount of visible light that articles susceptible to light damage should be illuminated with. In one embodiment, if a level of light in a range of about 75-100 lux is measured, for example by a light sensor placed at a position generally indicated as X, one or more circuit or circuit element 800 selectively causes a voltage V to be applied to material 100 to effectuate a state of its transparency to be more darkened. In one embodiment, if a level of light below a range of about 50-75 lux is measured at a position generally indicated as X, one or more circuit or circuit element 800 selectively causes a voltage V to be applied to material 100 to effectuate a state of its transparency to become less darkened. In this manner, illumination of an article can be controllably maintained to a particular comfortable viewing level between 50-100 lux and at the same time protect the article from damage that could occur from full exposure to any visible light that may be present at a position generally indicated as Y. In one embodiment, illumination of an article can be controllably maintained between 0-100 lux to protect the article from damage that could occur from full exposure to any visible light that may be present at a position generally indicated as Y.

Although a preferred range of lux for displaying and viewing articles has been described above to comprise about 50-100 lux, it is identified that other ranges may be desirable as well, as long as such ranges would be less than the amount of ambient visible light illumination that might be present at a position generally indicated as Y. For example, if an amount of ambient visible light illumination is 1000 lux, in some embodiments it might be adequate that the amount of illumination at a position generally indicated as X was maintained at some particular value or within a particular range less than 1000 lux, in which case, although an article might not be optimally protected from the effects of the visible light, because the illumination would be reduced, the effects would at least be slowed.

In an exemplary embodiment, a display material 900 comprises an area of about 24×24 square inches and a thickness of about ⅜ inch. In an exemplary embodiment, space 36 comprises a thickness of about ⅛ inch. In other embodiments, the display material 900 may comprise a thickness of on the order of 0.1 inch or less. In other embodiments, the display material 900 may comprise other geometries, other areas, and other thicknesses, as would be permitted, be necessary, or be desired for use in a particular application.

In exemplary embodiments, a display material 900 is appropriately dimensioned to shield, view, and display articles 300 that comprise one or more of: artifacts, paintings, art prints, philatelic items, photos, album pages, documents, books, storage boxes, antiques, jewelry, coins, liquids, inorganic articles, organic articles, display cases and other articles, the list of which is should be limited only the scope of the claims. In one embodiment, the display material 900 may be shaped in a form that is defined by a particular application, for example, in the shape of a bottle or container of liquid.

In one embodiment, a transparency of display material 900 can be made to change states between clear and darkened with application of voltages V that range between about +/−4 volts. It is identified that, if desired, when low operating voltages and/or power are used, as can be effectuated via use of electrochromic technology, a voltage source 400 and/or one or more circuit or circuit elements 800 can be made to comprise a small and light weight form factor. In one embodiment, a small and light weight form factor voltage source 400 allows display material 900 to be used in a wide number of both moveable and fixed applications, whether indoors or outdoors. For example, in one embodiment, a voltage source 400 may comprise a battery and/or battery conditioning circuit, both of which, if desired, can be placed or packaged with the display material 900, for example, as part of structure 451, all of which can then as needed or as desired be moved from location to location without need for external wiring, connections, and/or power sources 610.

Referring now to FIG. 4, and other Figures as needed, there is seen a representation of a display case. In FIG. 4 display material 900 is represented to comprise a transparency that is in a substantially darkened state. In an exemplary embodiment, a display material 900, voltage source 400 (not shown), and one or more circuit 800 (not shown) are packaged within and/or coupled to comprise a display frame 1000, which can, as desired, be used in a home, office, museum, exhibition hall or some other interior space 600. In an exemplary embodiment, display frame 1000 is used to selectively shield, or make viewable, a paper or paper like article 300, for example: a book, a letter, a document, an art item, an item of history, and the like.

In one embodiment, article 300 is coupled to and/or supported by display material 900 and/or a display frame 1000. In one embodiment, support of an article 300 to a display frame is functionally facilitated by a fastener, glue, an adhesive, or other coupler known to those skilled in the fastener arts. In the preferred embodiment, article 300 is placed on, coupled to, and/or supported by a support 1010. In embodiments, the support 1010 comprises, a plastic or plastic like material, a glass or glass like material, a paper or paper like material, or other material as known to those skilled in the support arts. In embodiments, support 1010 may comprise: a substantially inert plastic, a substantially non-acidic paper, or other material that would be expected to minimally interact with a particular article 300.

In a preferred embodiment, the display material 900 and/or a display frame 1000 is used to selectively make an article 300 available for viewing under, and at other times to selectively protect the article from the effects of, an artificial indoor source of light 200. In one embodiment, the display material 900 and/or a display frame 1000 is used as needed by direct or indirect placement over, or in front, of an article 300 desired to be selectively protected and/or viewed. In one embodiment, a display material 900 and/or a display frame 1000 may be mounted, coupled, or attached over, or attached to a viewing window of a prior art display case (not shown). In one embodiment, a display material 900 and/or a display frame 1000 are operatively and/or functionally coupled to a support 1010, the combination of which can be used to selectively display, exhibit, and at the same time protect an article 300 subject to the illumination of an artificial light source 200.

In one embodiment, a display material 900 and/or a display frame 1000 comprises at least one side of a display case 2000. In one embodiment, a display case 2000 comprises a display material 900, and/or a display frame 1000, and one or more side portions 1030, and/or one or more back portion 1020. In one embodiment, one or more of side portions 1030 are darkened. In one embodiment, one or more side portions 1030 and/or one or more back portion 1020 also comprise a display material 900. In one embodiment, the display case 2000 is sized appropriately to allow an article 300 to be fully viewed. In one embodiment, a display case 2000 comprises an interior that may be hermetically sealed from the exterior. In one embodiment, an interior of a display case 2000 is filled with an inert gas, for example, nitrogen, argon, or the like. In one embodiment, a temperature and/or humidity within a display case 2000 is controllably maintained. In one embodiment, an interior of a display case 2000 is controllably refrigerated. In one embodiment, a display material 900 and/or a display frame 1000 alone, or in combination with a display case 2000, are moveable for mounting on a wall, or a floor, or other position with an interior of a building, etc. In one embodiment, a display case 2000 comprises a form factor that allows it to be easily moved or held, as for example, in a viewers or users hand. In one embodiment, a display case 2000 comprises the dimensions of prior art “slabs” (not shown) as are used by Professional Stamp Experts (PSE) PO BOX 6170, Newport Beach, Calif. 92658 to encapsulate graded philatelic items. In an exemplary embodiment, a display case 2000 with “slab like” dimensions comprises about 2.4 inches×3.5 inches×0.2 inches. Unlike prior art display cases, a display case 2000 can, thus, provide protection against the effects of visible light and at the same time be easily moved, even to the point of fitting and movement within a hand. Furthermore, unlike the prior art, an article 300 held within a display case 2000 can easily be protected from light during periods of movement not only indoors, but outdoors as well, during which time if a transparency of display material 900 is maintained in a substantially darkened state, the article 300 can be protected from the effects of natural light 700 as well.

In an exemplary embodiment, a support 1010 is positioned so as to maintain an article 300 against a surface of the display material 900, for example, so that an article may be substantially held in place or supported between a surface of a support 1010 and a display material 900. In one embodiment, the support 1010 may be perforated or made to be breathable. In some embodiments, spacers or standoffs 1040 may be disposed or formed between and/or around a display material and/or a support 1010 to provide an article 300 with adequate ventilation and/or support.

In one embodiment, the support 1010 itself may comprise a display material 900, in which embodiment, a display case 2000 could, thus, protect and at the same time allow an article 300 to be selectively viewed from at least two sides of the display case, as is sometimes desired with articles such as historical documents, philatelic items, stamps, and the like.

Referring now to FIG. 5, and other Figures as needed, there is seen an exploded view of an exemplary apparatus. In one embodiment, a display material 900 is placed opposite or adjacent an article 300 and/or a page 3000. In embodiments, an article 300 and/or page 3000 is held against a display material 900 by one or more coupling fastener 3100, for example, adhesives, screws, de/attachable clips, clamps, magnets, other fasteners as could be implemented by those skilled in the fastener arts. In other embodiments, an article 300 and/or page 3000 is held against a display material 900 by a support and/or a second display material and/or a backing material 3100. In one embodiment, a display material 900, article 300 and/or page 3000, and fastener and/or backing material 3100 are coupled to one or more mechanism 3050 (hereafter referred to collectively as display page 3200). Although shown as being coupled to the display material 900, in other embodiments, the mechanism 3050 may be coupled to the fastener 3100, or both to the display material and the fastener and/or backing material 3100. In one embodiment, a fastener and/or backing material 3100 may itself provide the functionality of a mechanism 3050, in which case the mechanism 3050 might not necessarily need to be used. In an exemplary embodiment, a display page 3200 comprises one of a plurality of display pages. In one embodiment, a functionality of mechanism 3050 enables it to be coupled to a support mechanism 3070. In one embodiment, a functionality of support mechanism 3070 enables movement of one or more display page 3200 to be constrained, for example, as by one or more hinge (not shown), or other moveable constraint mechanism that could be implemented by those skilled in the art. In one embodiment, movement of display page 3200 is constrained by support mechanism 3070 in a direction indicated by the curved arrow.

In one embodiment, the one or more mechanism 3050 and/or the support mechanism 3070 include one or more connections 3080 that may be functionally coupled to enable a particular voltage V to be coupled to, or decoupled from, each display page 3200. In one embodiment, electrical coupling between electrical connections 3080 of each display page 3200 is enabled at one or more points of rotation of the display page about the support mechanism 3070, for example via appropriately disposed conductive traces 3075.

In the embodiment represented by FIG. 5, a display page 3200 is rotated to be in a viewing position, and via electrical connections 3080 application of voltage V is interrupted or applied to the display page 3200 to thereby change a transparency of display material 900 to a substantially clear state. In one embodiment (not shown), rotation of display page 3200 to a non-viewing position causes application of voltage V to be interrupted or to be applied to the display page 3200 to thereby change a transparency of display material 900 to a substantially darkened state. In this manner, as a display page 3200 is rotated, an article 300 and/or page 3000 can be made viewable, and subsequently when rotated from of view, protected from light and/or other effects of the environment. In one embodiment, one or more connections 3080 may be adapted to comprise slip fit electrical contacts that allow a display page 3200 to be decoupled and/or removed from mechanisms 3050 and/or 3070 quickly and easily.

Referring now to FIG. 6, and other Figures as needed, there is seen an exploded view of an exemplary apparatus. In embodiments, a display page 3200 is dimensioned to comprise a commonly sized form factor, for example, a standardized picture frame size, or dimensions of the aforementioned “slab.” In one embodiment, a frame 3095 comprises one or more electrical slip fit contacts 3026 that functionally and operatively correspond to electrical connections 3080 of a display page 3200. In one embodiment, a display page 3200 is mountable within a frame 3095, which can thereafter be placed for viewing or exhibition on a wall, a table, etc. In one embodiment, a frame 3095 is adapted to provide voltage V to the display page 3200 through electrical connections 3080, such that articles 300 can, thus, either via manual or via automated control of the voltage V be made available for viewing and/or display (i.e. via a clear state of a display material 900) or, similarly, shielded from view and/or ambient light (i.e. via a darkened state of a display material 900).

In one embodiment, in an indoor setting where display material 900 is illuminated under artificial visible light 200 and natural visible light 700 as may be present through a window, a maximum amount of light does not exceed about 5000 lux of illumination, in which embodiment, with a selective change in transparency of display material 900 from a substantially transparent state to a substantially darkened state, an article 300 would be exposed to a differential of illumination that would not exceed about 5000 lux.

In a preferred embodiment, in an indoor setting where display material 900 is illuminated under artificial visible light 200 only, a maximum amount of light does not exceed about 1000 lux of illumination, in which embodiment, with a selective change in transparency of display material 900 from a substantially transparent state to a substantially darkened state, an article 300 would be exposed to a differential of illumination that would not exceed about 1000 lux.

Referring now to FIG. 7, and other Figures as needed, there is seen a representation of a failure mode of a display material. In one embodiment, a display case 4000 may or may not be used to protect an article from the damaging effects of light, but is used to make an article 300 selectively visible or not visible. In one embodiment, an article 300 can be made selectively visible for viewing and, when needed, substantially invisible for security purposes. For example, with a display material 900 is in an opaque or darkened state, an article 300 can be shielded from the view of persons in its vicinity, whereas in a clear state the article can be made visible. In one embodiment, such visible or not visible functionality can be used in retail or museum environment, where during non-business or non-viewing hours an article 300 can be kept in a display case 4000 without persons in its vicinity knowing the article was present. In one embodiment, an article 300, which in the prior art may have been displayed during business hours in a storefront display case (not shown), and which would be removed from the display case for storage during non-business hours to prevent its theft, can now be kept in a display case 4000 continuously. In one embodiment, a display material may comprise a hardened and/or laminated shatterproof type of glass. Thus, because a display case 4000 can be selectively kept in a darkened state, an article 300 can be made more secure and less tempting to steal.

In one embodiment, it is identified that during application of voltage V, a small current flows through layers of display material 900. In one embodiment, failure of this current flow may be caused by cracking, breaking, smashing, degradation, or some other failure 4100 of the display material 900. In one embodiment, failure of the display material 900 is used to provide security or alarm functionality. In one embodiment, failure of the current flow is sensed by one or more circuit or circuit element 800, which in turn may be used to generate a signal or trigger an alarm.

This document describes inventive embodiments that include apparatus and methods for shielding and protecting articles from the effects in considerable detail. This was done for illustration purposes. Neither the specific embodiments of the invention as a whole, nor those of its features, limit the general principles underlying the invention. The specific features described herein may be used in some embodiments, but not in others, without departure from the spirit and scope of the invention as set forth. Many additional modifications are intended in the foregoing disclosure, and it will be appreciated by those of ordinary skill in the art that, in some instances, some features of the invention will be employed in the absence of a corresponding use of other features. The illustrative examples therefore do not define the metes and bounds of the invention and the legal protection afforded the invention, which should be limited only by the appended claims.

What is claimed is:

1. At least one display window for selectively shielding articles from illumination emanating from one or more artificial light source, comprising:
a display material capable of having a plurality of states of transparency that are electrically controllable to selectively pass the illumination through the display material and so as to selectively limit illumination of articles in the path of the illumination, wherein after the illumination passes through the display material it is limited by the display material to a predetermined amount of illumination.

2. The at least one display window according to claim 1, wherein the artificial light source is selected from a group consisting of: incandescent, halogen, fluorescent, tungsten, arc, tungsten halogen, high-intensity discharge, LED, Low Pressure Sodium, Metal Halide, and Mercury Vapor light sources.

3. The at least one display window of claim 1, wherein the display material comprises at least one layer of electrochromic material.

4. The at least one display window of claim 1, wherein the display material is coupled to at least one circuit element, wherein upon detection of an event, the at least one circuit element generates a signal, and wherein the signal is functionally coupled to the display material to change a state of its transparency from a first state to a second state.

5. The at least one display window of claim 4, wherein the detection of an event is selected from the group consisting of: an amount of visible light illumination, an amount of infrared light illumination, an amount of UV light illumination, an environmental condition, presence of an article, presence of person, or a time of day.

6. The at least one display window of claim 4, wherein the detection of an event comprises a measurement of an amount of the illumination before the illumination passes through the display material.

7. The at least one display window of claim 4, wherein the detection of an event comprises a measurement of an amount of the illumination after the illumination passes through the display material.

8. The at least one display window of claim 7, wherein when the measurement comprises more than a particular value, the signal is operatively coupled to the display material to change a state of the display material to be more darkened, and wherein when the measurement comprises less than the particular value, the signal is operatively coupled to the display material to change a state of the display material to less darkened.

9. The at least one display window of claim 8, wherein the predetermined amount of illumination is in a range between about 50 lux and about 100 lux.

10. The at least one display window of claim 8, wherein the predetermined amount of illumination is less than about 500 lux.

11. An apparatus to control illumination of one or more article by visible light, comprising:
a display case, the display case comprising a plurality of side portions, wherein the side portions define a space within which the one or more articles can be disposed, wherein at least one of the plurality of side portions comprises a material that can be controlled to have a plurality of transparencies; and
a source of voltage, wherein a selective application of the voltage to the material controllably changes a transparency of the material, wherein during periods of viewing of any articles that may be disposed within the space a selective application of the voltage is used to change a transparency of the material to allow the space to be illuminated with a level of the visible light that is comfortable for viewing and at the same time to limit damage that could be caused to the articles by the visible light, and wherein during periods of non-viewing a selective application of the voltage is used to change a transparency of the material to be in a substantially darkened state to further limit visible light damage to any of the articles that may be disposed within the space.

12. The apparatus of claim 11, wherein the material comprises an electrochromic material.

13. The apparatus of claim 11, wherein articles that may be disposed within the space are selected from a group consisting of: paintings, art prints, art items, philatelic items, stamps, photos, documents, letters, books, and artifacts.

14. The apparatus of claim 13, wherein the display case comprises a moveable frame.

15. The apparatus of claim 11, wherein a difference in the amount of illumination present within the space when a transparency of the material is changed between a substantially clear state and a substantially darkened state does not exceed about 2000 lux.

16. A method of displaying and protecting an article placed under the illumination of visible light, comprising:
positioning an article on a support;
positioning an electrochromic material between the article and a source of the visible light; and
electrically controlling a transparency of the electrochromic material to controllably vary illumination of the article by the visible light.

17. The method of claim 16, wherein the illumination of the article is controllably limited to a value.

18. The method of claim 17, wherein the value is in a range of about 50 to 500 lux.

19. The method of claim 18, wherein the visible light comprises artificial visible light.

20. The method of claim 19, wherein the article is selected from a group consisting of:
paintings, art prints, art items, philatelic items, stamps, photos, album pages, documents, letters, books, artifacts, and storage containers.
